(19) United States
(12) Patent Application Publication
(10) Pub. No.: US 2026/0040379 A1
(43) Pub. Date: Feb. 5, 2026

(54) NETWORK CONTROL OF MULTI-PATH SIDELINK OPERATION

(71) Applicant: QUALCOMM Incorporated, San Diego, CA (US)

(72) Inventors: Jianhua LIU, Beijing (CN); Karthika PALADUGU, Hyderabad (IN); Hong CHENG, Basking Ridge, NJ (US); Qing LI, Princeton Junction, NJ (US)

(21) Appl. No.: 19/101,224

(22) PCT Filed: Sep. 30, 2022
(86) PCT No.: PCT/CN2022/123001

§ 371 Date: Feb. 4, 2025

(51) Int. Cl. H04W 76/15; H04L 47/24; H04W 72/25

(52) U.S. Cl. CPC H04W 76/15; H04L 47/24; H04W 72/25

(57) ABSTRACT

Methods, systems, and devices for wireless communications are described. A first user equipment (UE) may establish an end-to-end link with a second UE for communicating traffic associated with a service, the end-to-end link including a first path. The first UE may transmit, via the end-to-end link, an indication of a configuration for a second path between the first UE and the second UE, where the configuration for the second path is based on service information associated with the service. The first UE may communicate, with the second UE, traffic associated with the service via the first path or the second path based on transmitting the indication of the configuration for the second path.

### CROSS REFERENCE

This application is a 371 National Stage of PCT Application No. PCT/CN2022/123001, filed on Sep. 30, 2022, entitled “NETWORK CONTROL OF MULTI-PATH SIDELINK OPERATION”, and assigned to the assignee hereof. The disclosure of the prior Application is considered part of and is incorporated by reference into this Patent Application.

### FIELD OF TECHNOLOGY

The following relates to wireless communications, including network control of multi-path sidelink operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a first user equipment (UE) may communicate with a second UE using a single path. For instance, the first UE may communicate with the second UE directly or may communicate with the second UE using a relay UE. Techniques that enable the first UE to communicate with the second UE via more than one path may increase the efficiency of wireless communications. However, supporting multiple paths for communication between UEs presents challenges in managing the paths for communication.

### SUMMARY

The described techniques relate to improved methods, systems, devices, and apparatuses that support network control of multi-path sidelink operation. For example, the described techniques provide for a first user equipment (UE) to set up multiple paths with a second UE according to a multi-path rule. For instance, the first UE may establish an end-to-end link with the second UE for communicating traffic associated with a service, the end-to-end link including a first path. The first UE may transmit, via the end-to-end link, an indication of a configuration for a second path between the first UE and the second UE, where the configuration for the second path is based on service information associated with the service. The first UE may communicate, with the second UE, traffic associated with the service via the first path or the second path based on transmitting the indication of the configuration for the second path.

A method for wireless communication at a first user equipment (UE) is described. The method may include establishing an end-to-end link with a second UE for communicating traffic associated with a service, the end-to-end link including a first path, transmitting, via the end-to-end link, an indication of a configuration for a second path between the first UE and the second UE, where the configuration for the second path is based on service information associated with the service, and communicating, with the second UE, traffic associated with the service via the first path or the second path based on transmitting the indication of the configuration for the second path.

An apparatus for wireless communication at a first UE is described. The apparatus may include a processor, memory coupled with the processor, and instructions stored in the memory. The instructions may be executable by the processor to cause the apparatus to establish an end-to-end link with a second UE for communicating traffic associated with a service, the end-to-end link including a first path, transmit, via the end-to-end link, an indication of a configuration for a second path between the first UE and the second UE, where the configuration for the second path is based on service information associated with the service, and communicate, with the second UE, traffic associated with the service via the first path or the second path based on transmitting the indication of the configuration for the second path.

Another apparatus for wireless communication at a first UE is described. The apparatus may include means for establishing an end-to-end link with a second UE for communicating traffic associated with a service, the end-to-end link including a first path, means for transmitting, via the end-to-end link, an indication of a configuration for a second path between the first UE and the second UE, where the configuration for the second path is based on service information associated with the service, and means for communicating, with the second UE, traffic associated with the service via the first path or the second path based on transmitting the indication of the configuration for the second path.

A non-transitory computer-readable medium storing code for wireless communication at a first UE is described. The code may include instructions executable by a processor to establish an end-to-end link with a second UE for communicating traffic associated with a service, the end-to-end link including a first path, transmit, via the end-to-end link, an indication of a configuration for a second path between the first UE and the second UE, where the configuration for the second path is based on service information associated with the service, and communicate, with the second UE, traffic associated with the service via the first path or the second path based on transmitting the indication of the configuration for the second path.

In some examples of the method, apparatuses, and non-transitory computer-readable medium described herein, transmitting the indication of the configuration for the second path may include operations, features, means, or instructions for transmitting, via the end-to-end link, an indication of whether the second path may be associated with a split bearer or a standalone bearer, where communicating the traffic associated with the service via the first path or the second path may be based on transmitting the indication of whether the second path may be associated with the split bearer or the standalone bearer.

In some examples of the method, apparatuses, and non-transitory computer-readable medium described herein, transmitting the indication of the configuration for the second path may include operations, features, means, or instructions for transmitting, via the end-to-end link, an indication of a quantity of paths, where communicating the traffic associated with the service via the first path or the second path may be based on transmitting the indication of the quantity of paths.

In some examples of the method, apparatuses, and non-transitory computer-readable medium described herein, transmitting the indication of the configuration for the second path may include operations, features, means, or instructions for transmitting, via the end-to-end link, an indication of an access type for the second path, where communicating the traffic associated with the service via the first path or the second path may be based on transmitting the indication of the access type for the second path.

In some examples of the method, apparatuses, and non-transitory computer-readable medium described herein, the indication of the access type includes an indication of a set of access types and the method, apparatuses, and non-transitory computer-readable medium may include further operations, features, means, or instructions for transmitting, via the end-to-end link, an indication of the service information, receiving, from the second UE, an indication of a subset of the set of access types, and communicating the traffic associated with the service via the first path or the second path based on receiving the indication of the subset of the set of access types.

In some examples of the method, apparatuses, and non-transitory computer-readable medium described herein, transmitting the indication of the configuration for the second path may include operations, features, means, or instructions for transmitting, via the end-to-end link, an indication of whether the second path may be a direct path from the first UE to the second UE or may be a relay path, where the relay path includes at least one hop from the first UE to the second UE via at least one relay UE.

Some examples of the method, apparatuses, and non-transitory computer-readable medium described herein may further include operations, features, means, or instructions for transmitting, to the second UE, an indication of a bearer configuration, where the bearer configuration may be based on the service information and receiving, from the second UE, an indication that the second UE accepts the bearer configuration, where communicating the traffic associated with the service via the first path or the second path may be based on receiving the indication that the second UE accepts the bearer configuration.

Some examples of the method, apparatuses, and non-transitory computer-readable medium described herein may further include operations, features, means, or instructions for determining the configuration for the second path at a first layer of the first UE based on the service information, providing the configuration for the second path and an indication of a quality of service (QOS) flow to a second layer of the first UE, and communicating the traffic associated with the service via the first path or the second path based on providing the configuration for the second path and the indication of the QoS flow to the second layer of the first UE.

In some examples of the method, apparatuses, and non-transitory computer-readable medium described herein, the first layer includes a proximity services layer and the second layer includes a radio resource control layer.

Some examples of the method, apparatuses, and non-transitory computer-readable medium described herein may further include operations, features, means, or instructions for providing, by a first layer of the first UE, the service information and a quality of service (QOS) flow to a second layer of the first UE, determining the configuration for the second path at the second layer based on the provided service information, and communicating the traffic associated with the service via the first path or the second path based on determining the configuration for the second path at the second layer.

Some examples of the method, apparatuses, and non-transitory computer-readable medium described herein may further include operations, features, means, or instructions for providing, by the first layer of the first UE, an identifier of the first UE, an identifier of the second UE, or both, where determining the configuration for the second path may be based on the identifier of the first UE, the identifier of the second UE, or both.

In some examples of the method, apparatuses, and non-transitory computer-readable medium described herein, the first layer includes a proximity services layer and the second layer includes a radio resource control layer.

In some examples of the method, apparatuses, and non-transitory computer-readable medium described herein, the service information includes an indication of a service type, an indication of an application layer, an indication of a packet filter set, or any combination thereof.

A method for wireless communication at a first UE is described. The method may include establishing an end-to-end link with a second UE for communicating traffic associated with a service, the end-to-end link including a first path, receiving, via the end-to-end link, an indication of a configuration for a second path between the first UE and the second UE, where the configuration for the second path is based on service information associated with the service, and communicating, with the second UE, traffic associated with the service via the first path or the second path based on transmitting the indication of the configuration for the second path.

An apparatus for wireless communication at a first UE is described. The apparatus may include a processor, memory coupled with the processor, and instructions stored in the memory. The instructions may be executable by the processor to cause the apparatus to establish an end-to-end link with a second UE for communicating traffic associated with a service, the end-to-end link including a first path, receive, via the end-to-end link, an indication of a configuration for a second path between the first UE and the second UE, where the configuration for the second path is based on service information associated with the service, and communicate, with the second UE, traffic associated with the service via the first path or the second path based on transmitting the indication of the configuration for the second path.

Another apparatus for wireless communication at a first UE is described. The apparatus may include means for establishing an end-to-end link with a second UE for communicating traffic associated with a service, the end-to-end link including a first path, means for receiving, via the end-to-end link, an indication of a configuration for a second path between the first UE and the second UE, where the configuration for the second path is based on service information associated with the service, and means for communicating, with the second UE, traffic associated with the service via the first path or the second path based on transmitting the indication of the configuration for the second path.

A non-transitory computer-readable medium storing code for wireless communication at a first UE is described. The code may include instructions executable by a processor to establish an end-to-end link with a second UE for communicating traffic associated with a service, the end-to-end link including a first path, receive, via the end-to-end link, an indication of a configuration for a second path between the first UE and the second UE, where the configuration for the second path is based on service information associated with the service, and communicate, with the second UE, traffic associated with the service via the first path or the second path based on transmitting the indication of the configuration for the second path.

In some examples of the method, apparatuses, and non-transitory computer-readable medium described herein, receiving the indication of the configuration for the second path may include operations, features, means, or instructions for receiving, via the end-to-end link, an indication of whether the second path may be associated with a split bearer or a standalone bearer, where communicating the traffic associated with the service via the first path or the second path may be based on transmitting the indication of whether the second path may be associated with the split bearer or the standalone bearer.

In some examples of the method, apparatuses, and non-transitory computer-readable medium described herein, receiving the indication of the configuration for the second path may include operations, features, means, or instructions for receiving, via the end-to-end link, an indication of a quantity of paths, where communicating the traffic associated with the service via the first path or the second path may be based on transmitting the indication of the quantity of paths.

In some examples of the method, apparatuses, and non-transitory computer-readable medium described herein, receiving the indication of the configuration for the second path may include operations, features, means, or instructions for receiving, via the end-to-end link, an indication of an access type for the second path, where communicating the traffic associated with the service via the first path or the second path may be based on transmitting the indication of the access type for the second path.

In some examples of the method, apparatuses, and non-transitory computer-readable medium described herein, the indication of the access type includes an indication of a set of access types and the method, apparatuses, and non-transitory computer-readable medium may include further operations, features, means, or instructions for receiving, via the end-to-end link, an indication of the service information, transmitting, to the second UE, an indication of a subset of the set of access types, and communicating the traffic associated with the service via the first path or the second path based on receiving the indication of the subset of the set of access types.

In some examples of the method, apparatuses, and non-transitory computer-readable medium described herein, receiving the indication of the configuration for the second path may include operations, features, means, or instructions for receiving, via the end-to-end link, an indication of whether the second path may be a direct path from the first UE to the second UE or may be a relay path, where the relay path includes at least one hop from the first UE to the second UE via at least one relay UE.

Some examples of the method, apparatuses, and non-transitory computer-readable medium described herein may further include operations, features, means, or instructions for receiving, from the second UE, an indication of a bearer configuration, where the bearer configuration may be based on the service information and transmitting, to the second UE, an indication that the first UE accepts the bearer configuration, where communicating the traffic associated with the service via the first path or the second path may be based on transmitting the indication that the first UE accepts the bearer configuration.

In some examples of the method, apparatuses, and non-transitory computer-readable medium described herein, the service information includes an indication of a service type, an indication of an application layer, an indication of a packet filter set, or any combination thereof.

### BRIEF DESCRIPTION OF THE DRAWINGS

FIG. 1 illustrates an example of a wireless communications system that supports network control of multi-path sidelink operation in accordance with one or more aspects of the present disclosure.

FIG. 2 illustrates an example of a wireless communications system that supports network control of multi-path sidelink operation in accordance with one or more aspects of the present disclosure.

FIG. 3 illustrates an example of a path establishment flow that supports network control of multi-path sidelink operation in accordance with one or more aspects of the present disclosure.

FIG. 4 illustrates an example of a multi-path rule implementation that supports network control of multi-path sidelink operation in accordance with one or more aspects of the present disclosure.

FIG. 5 illustrates an example of a process flow that supports network control of multi-path sidelink operation in accordance with one or more aspects of the present disclosure.

FIGS. 6 and 7 show block diagrams of devices that support network control of multi-path sidelink operation in accordance with one or more aspects of the present disclosure.

FIG. 8 shows a block diagram of a communications manager that supports network control of multi-path sidelink operation in accordance with one or more aspects of the present disclosure.

FIG. 9 shows a diagram of a system including a device that supports network control of multi-path sidelink operation in accordance with one or more aspects of the present disclosure.

FIGS. 10 through 13 show flowcharts illustrating methods that support network control of multi-path sidelink operation in accordance with one or more aspects of the present disclosure.

### DETAILED DESCRIPTION

In some examples, a first user equipment (UE) may communicate with a second UE using multiple (e.g., two or more) paths. For instance, the first UE may transmit a first transmission to the second UE directly along a first path and may transmit a second transmission to the second UE along a second path using a third UE as a relay. In some examples, the multiple paths may have one or more associated communication parameters. For instance, each path may have an associated access type (e.g., licensed vs unlicensed), path type (e.g., direct or relay), bearer type (e.g., split-bearer or separate bearer), or any combination thereof. In some examples, certain constraints on values of the one or more communication parameters may be present. However, if the first UE and/or the second UE have failed to determine these constraints for a particular service, the first UE and/or the second UE may errantly use values for the one or more communication parameters that do not adhere to these constraints.

In order to enable the UE to determine the communication parameter values to use for a particular service, the UE may be configured with a multi-path rule indicating a mapping between service information and the one or more communication parameters. For instance, the first UE may establish an end-to-end link with a second UE for communicating traffic associated with a service, the end-to-end link including a first path. The first UE may transmit, via the end-to-end link, an indication of a configuration for a second path (e.g., an indication of the one or more communication parameters), where the configuration for the second path is based on service information associated with the service. The first UE may communicate, with the second UE, the traffic associated with the service via the first path or the second path based on transmitting the indication of the configuration for the second path.

In some examples, the multi-path rule may be implemented at a proximity services (ProSe) layer. For instance, the first UE may determine, from service information and using the multi-path rule, the one or more communication parameters at the ProSe layer and may provide the one or more communication parameters to a radio resource control (RRC) layer, where the RRC layer may set up the second path according to the provided one or more communication parameters. In other examples, the multi-path rule may be implemented at the RRC layer. For instance, the ProSe layer may provide the service information to the RRC layer and the first UE may determine, at the RRC layer, the one or more communication parameters from the service information according to the multi-path rule. The first UE may then set up the second path according to the determined one or more communication parameters. Additionally or alternatively, the first UE may transmit, to the second UE, an indication of the service information and at least one of the one or more communication parameters (e.g., an access type), where the second UE may indicate, to the first UE, whether or not the second UE supports or accepts the at least one of one or more communication parameters corresponding to the service information. The first UE may then set up the second path according to the indication that the second UE supports or accepts the at least one of the one or more communication parameters.

Aspects of the disclosure are initially described in the context of wireless communications systems. Additional aspects of the disclosure are described in the context of a path establishment flow, a multi-path rule implementation, and a process flow. Aspects of the disclosure are further illustrated by and described with reference to apparatus diagrams, system diagrams, and flowcharts that relate to network control of multi-path sidelink operation.

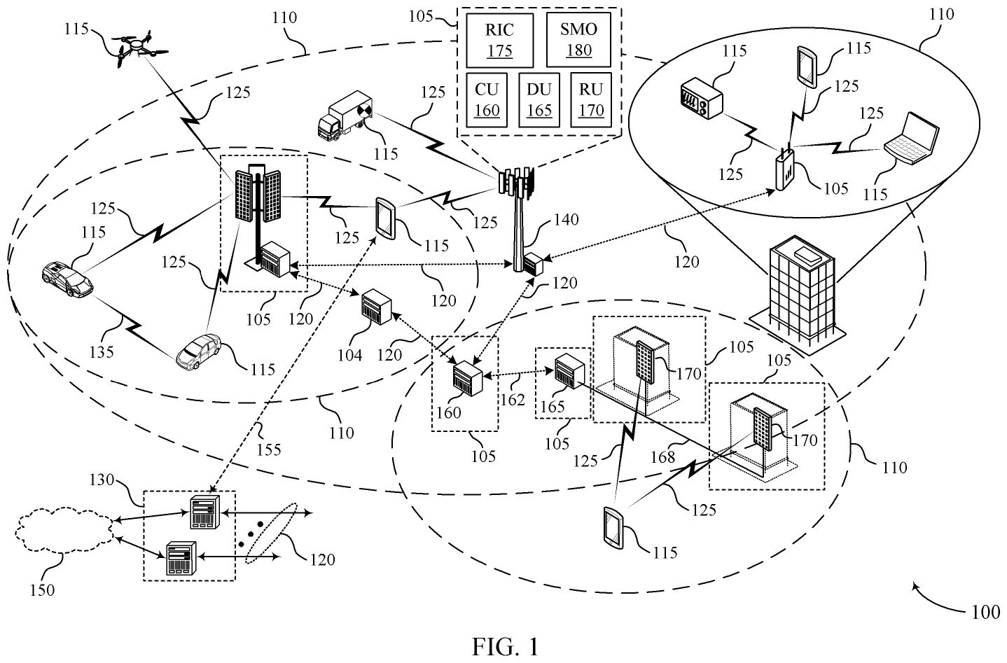

FIG. 1 illustrates an example of a wireless communications system 100 that supports network control of multi-path sidelink operation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support network control of multi-path sidelink operation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a first UE 115 may act as a relay for communications from a second UE 115 to a third UE 115. In such examples, the UE 115 that relays traffic between the second UE 115 and the third UE 115 (e.g., first UE 115) may be referred to as a relay UE 115. The originator of the relayed traffic may be referred to as the source UE 115 (e.g., second UE 115) and the destination of the relayed traffic may be referred to as the destination UE 115 (e.g., third UE 115). If a single relay UE 115 is present between a source UE 115 and a destination UE 115, a single-hop relay may be present. If multiple relay UEs are present between the source UE 115 and the destination UE 115, a multi-hop relay may be present.

In some examples, remote UEs 115 may support dual path connection over two relays. For instance, a remote UE 115 may be connected with two relays using PC5 or non-3GPP radio access technology (RAT) access, where PC5 can be on a licensed or unlicensed frequency band. Alternatively, remote UEs 115 may support dual path connections over one relay and one direct path. In either case, each path may be used for end-to-end traffic aggregation or duplication and at least one end to end signaling radio bearer (SRB) or data radio bearer (DRB) may be applied.

In some examples, for different application or constraints, different management or policies on a bearer type or access type may be specified. However, during multi-path connection establishment, if there is no rule or network control in the remote UE for determining which path type, bearer type, or access type to be used, then the remote UE may be incapable of determining these types for a particular service. The present disclosure describes how a network may control a UE 115 to perform a multi-path operation.

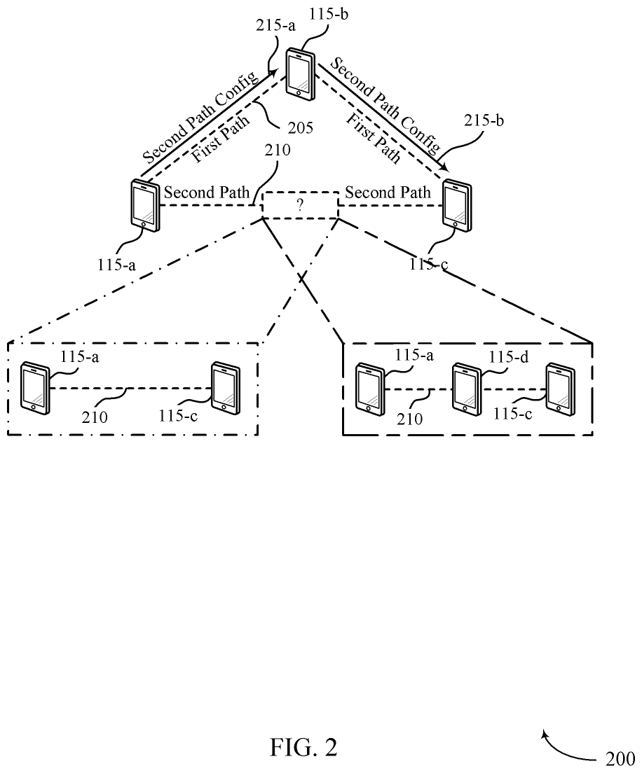

FIG. 2 illustrates an example of a wireless communications system 200 that supports network control of multi-path sidelink operation in accordance with one or more aspects of the present disclosure. In some examples, wireless communications system 200 may be implemented by one or more aspects of wireless communications system 100. For instance, UEs 115-a, 115-b, and 115-c may be examples of UEs 115 as described with reference to FIG. 1. Additionally, UE 115-a may be an example of a source UE, UE 115-b may be an example of a relay UE, and UE 115-c may be an example of a destination UE.

In some examples, UE 115-a may communicate with UE 115-c using multiple (e.g., two or more) paths. For instance, UE 115-a may communicate with UE 115-c along a first path 205 using UE 115-b as a relay and may communicate with UE 115-c along a second path 210 that may be a direct path between UE 115-a and UE 115-c or may have one or more relay UEs 115 (e.g., UE 115-d) that may relay communications along the second path 210 between UE 115-a and UE 115-c.

In some examples, the multiple paths may have one or more associated communication parameters. For instance, each path may have an associated access type. For instance, each of the first path 205 or the second path 210 may be associated with licensed PC5 communications, unlicensed PC5 communications, or non-3GPP communications. Additionally or alternatively, each path may have an associated path type. For instance, in the present example, first path 205 may be a relay path, whereas second path 205 may be one of a relay path or a direct path. In some examples, the path type may also indicate a number of hops (e.g., n, where n may be a number of hops and/or a number of relay UEs between UE 115-a and UE 115-c). Additionally or alternatively, each path may have an associated bearer type. For instance, first path 205 and second path 210 may be in a split bearer configuration or, alternatively, first path 205 and second path 210 may each be associated with a separate bearer. In some examples, the bearer type may be expressed as a quantity of paths. For instance, a quantity of 1 may indicate that the path has a separate bearer, whereas a quantity greater than 1 (e.g., 2) may indicate that the path is part of a split bearer configuration.

In some examples, certain constraints on values of the one or more communication parameters may be present. However, if UE 115-a and UE 115-c have failed to determine these constraints for a particular service, UE 115-a and/or UE 115-c may errantly use values for the one or more communication parameters that do not adhere to these constraints. Additionally or alternatively, one set of values for a particular path may be associated with improved signaling characteristics (e.g., a higher SNR, a higher SINR, a higher link efficiency) for a particular service as compared to another set of values for the particular service. However, without information indicating which of these communication parameter values are associated with the improved signaling characteristics, the UE may be incapable of determining these communication parameter values.

In order to enable UE 115-a and/or UE 115-c to determine the communication parameter values to use for a particular service, UEs 115-a and/or 115-c may be configured with a multi-path rule indicating a mapping between service information and the one or more communication parameters. For instance, UE 115-a may establish an end-to-end link with UE 115-c for communicating traffic associated with a service, the end-to-end link including first path 205. UE 115-a may transmit, via the end-to-end link, an indication of a configuration 215-a for a second path 210 (e.g., an indication of the one or more communication parameters), where the configuration 215-a for the second path is based on service information associated with the service. The configuration 215-a may be received at UE 115-b and may be relayed to UE 115-c as a configuration 215-b for the second path. UE 115-a may communicate, with UE 115-c) the traffic associated with the service via first path 205 or second path 210 based on transmitting the indication of the configuration 215-a for the second path. In some examples, the service information may include an indication of a service type, an indication of an application layer, an indication of a packet filter set, or any combination thereof.

In some examples (e.g., when applied for L2-based relay), the multi-path rule may be implemented at a ProSe layer. For instance, the UE 115-a may determine, from service information and using the multi-path rule, the one or more communication parameters at the ProSe layer and may provide the one or more communication parameters to a RRC layer, where the RRC layer may set up the second path 210 according to provided one or more communication parameters. In some such examples, the ProSe layer may determine the values of the one or more communication parameters for each PC5 quality of service (QOS) flow based on the multi-path rule when generating a QoS flow or QoS flow rule. Additionally, the ProSe layer may provide the one or more communication parameters along with the QoS flow to the RRC layer, where the RRC layer may configure a bearer for the QoS flow based on the received one or more communication parameters.

As described herein, the multi-path rule implemented at the ProSe layer may be used for L2-based UAV to UAV relay, at least in some examples. In some such examples, the multi-path rule may be configured by a core network. Additionally, in such examples, the one or more communication parameters (e.g., bearer or path information, such as bearer type, path type, or access type) for each PC5 QoS flow may be determined based on the multi-path rule when generating a QoS flow or a QoS flow rule. In some such examples, the multi-path rule may be defined as the mapping between the one or more communication parameters (e.g., bearer or path information, such as bearer type, path type, or access type) and service information (e.g., service type, constraints, a packet filter, or a packet filter set). For instance, the bearer may be a split bearer (e.g., two-path) or a standalone bearer (e.g., single-path). The split bearer may includeone end-to-end radio bearer with separate radio link control (RLC) bearers on different paths. The standalone bearer may be one end-to-end bearer with one RLC bearer on one path. The path information may also include whether or not a path is a relay path or a direct path. In some examples, the access type may be an access technology, such as PC5 on a licensed frequency band, PC5 on an unlicensed frequency band, or non-3GPP technology. In some examples, the mapping may be a list (e.g., one instance of service information may be mapped to a list of path information). In some examples, for each of one or more bearers, there may be one access type to be determined.

In some examples, the ProSe layer may include path information in QoS context and a QoS rule. In some examples, the ProSe layer may provide path information together with the QoS flow to the RRC layer. In some examples, the RRC layer may configure a corresponding bearer and an access type for the QoS flow according to the path information. In some examples, when the ProSe layer provides QoS flow to the RRC layer, the ProSe layer may provide QoS flow information and bearer information to the RRC layer.

Below is a table that demonstrates an example of the multi-path rule when configured in the ProSe layer:

TABLE 1
Multi-path rule in the ProSe Layer

| Service | Derived QoS Flow | |
|---|---|---|
| Information | Information | Path Information |
| IP address 1 | PC5 QoS parameters: | Bearer type: split bearer and |
| | PQI = 90, PDB = 10 | standalone bearer (or single- |
| | ms, PER = 10⁻⁴, | path, multi-path) |
| | PFI = 1 | Access type: 3GPP on a |
| | | licensed frequency |
| | | Path type: direct path |
| Application | PC5 QoS parameters: | Bearer type: split bearer and |
| requirements | PQI = 59, PDB = 500 | standalone bearer (or single- |
| 1 | ms, PER = 10⁻¹, | path, multi-path) |
| | PFI = 2 | Access type: 3GPP on a |
| | | licensed frequency, 3GPP on an |
| | | unlicensed frequency, non- |
| | | 3GPP |
| | | Path type: direct path, direct |
| | | path |
| Service type | PC5 QoS parameters: | Bearer type: standalone bearer |
| 1 | PQI = 22, PDB = 50 | Access type: 3GPP on a |
| | ms, PER = 10⁻², | licensed frequency |
| | PFI = 2 | Path type: direct path, direct |
| | | path |

In some such examples, PQI may be defined as a PC5 QOS indicator (e.g., where higher numbers may, for example, indicate a higher priority QoS), PDB may be defined as a packet delay budget, PER may be defined as a packet error rate, and PFI may be defined as a packet flow identity.

In some examples (e.g., when applied for L2-based relay), the multi-path rule may be implemented at the RRC layer. For instance, the ProSe layer may provide the service information to the RRC layer and UE 115-a may determine, at the RRC layer, the one or more communication parameters from the service information according to the multi-path rule. UE 115-a may then set up the second path 210 according to the determined one or more communication parameters.

Below is a table that demonstrates an example of the multi-path rule when configured in the RRC layer:

TABLE 2
Multi-path rule in the RRC Layer

| QoS flow information | |
|---|---|
| in NAS layer | Path information configured in RRC layer |
| PC5 QoS parameters: | Bearer type: split bearer and standalone |
| PQI = 90, PDB = 10 ms, | bearer (or single-path, multi-path) |
| PER = 10⁻⁴, PFI = 1 | Access type: 3GPP on a licensed frequency |
| | Path type: direct path |
| PC5 QoS parameters: | Bearer type: split bearer and standalone |
| PQI = 59, PDB = 500 ms, | bearer (or single-path, multi-path) |
| PER = 10⁻¹, PFI = 2 | Access type: 3GPP on a licensed frequency, |
| | 3GPP on an unlicensed frequency, non-3GPP |
| | Path type: direct path, direct path |
| PC5 QoS parameters: | Bearer type: standalone bearer |
| PQI = 22, PDB = 50 ms, | Access type: 3GPP on a licensed frequency |
| PER = 10⁻², PFI = 2 | Path type: direct path, direct path |

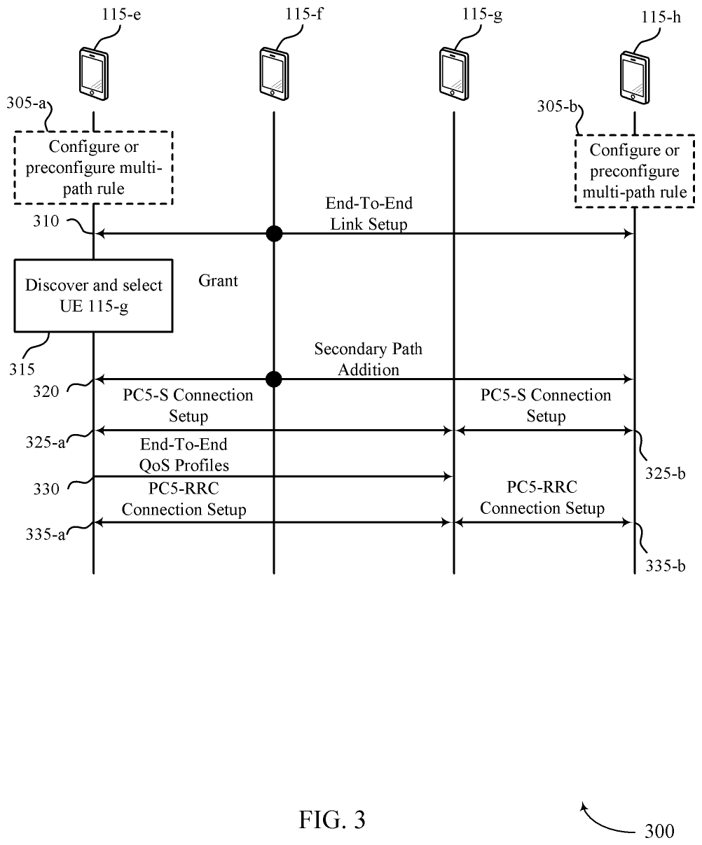

In some examples, when the ProSe layer provides the QOS flow and Qos parameters to the RRC layer, the RRC layer may determine the path information based on the configured multi-path rule. Additional details about the application of the multi- path rule to the ProSe layer and the RRC layer may be described herein, for instance, with reference to FIG. 3.

In some examples (e.g., when applied for L3-based unmanned aerial vehicle (UAV) to UAV relay communications), UE 115-a may transmit, to UE 115-b or UE 115-c, an indication of the service information and at least one of the one or more communication parameters (e.g., an access type), where the UE 115-b or UE 115-c may indicate, to UE 115-a, whether or not UE 115-b or UE 115-c supports or accepts the at least one of one or more communication parameters corresponding to the service information. UE 115-a may then set up the second path 210 according to the indication that UE 115-b or UE 115-c supports or accepts the at least one of the one or more communication parameters.

In some examples in which UE 115-c transmits the indication of the service information to UE 115-b or 115-c, UEs 115-a, 115-b, and/or 115-c may be configured or pre-configured with the multi-path rule in the ProSe layer. In some such examples, the multi-path rule may be configured by a core network using a non-access stratum (NAS) message (e.g., a Registration Accept or a UE Configuration Update message) or may be pre-configured. In some examples, UEs 115-a and/or 115-c may determine path information (e.g., path type, access type) for each service data flow (SDF). In some examples, the multi-path rule may be defined as a mapping between path information (e.g., path type, access type) and service information (e.g., service type, an application (APP) identifier (ID), a packet filter, a packet filter set). In some such examples, the access type may be an access technology, such as PC5 on a licensed frequency band, PC5 on an unlicensed frequency band, or non-3GPP technology. In some examples, the mapping may be a list (e.g., one instance of service information may be mapped to a list of path information). In some examples the source UE (e.g., UE 115-a) may initiate a direct communication request (e.g., PC5-S) with a peer UE (e.g., UE 115-b if along a relay path or UE 115-c is along a direct path) with the service information. The peer UE (e.g., UE 115-b or UE 115-c) may feedback accepted access types. If the peer UE (e.g., UE 115-b or UE 115-c) does not accept any of the access types based on the multi-path rule, the peer UE (e.g., UE 115-b or UE 115-c) may reject the service.

In some examples, applying the methods described herein may be associated with one or more advantages. For instance, implementing a multi-path rule at UEs 115-a, 115-b, or 115-c may enable UEs 115-a, 115-b, or 115-c to use multiple paths while meeting constraints specific to each instance of service information. Additionally or alternatively, one set of values for a particular path may be associated with improved signaling characteristics (e.g., a higher SNR, a higher SINR, a higher link efficiency) for a particular service as compared to another set of values for the particular service. If these values are configured at UEs 115-a, 115-b, and/or 115-c, UEs 115-a, 115-b, and/or 115-c may be capable of communicating according to the improved signaling characteristics for each instance of service information.

FIG. 3 illustrates an example of a path establishment flow 300 that supports network control of multi-path sidelink operation in accordance with one or more aspects of the present disclosure. In some examples, path establishment flow 300 may be implemented by one or more aspects of wireless communications systems 100 and/or 200. For instance, each of UEs 115-e, 115-f, 115-g, and 115-h may be examples of UEs 115 as described with reference to FIG. 1. Additionally or alternatively, UE 115-e may be an example of UE 115-a as described with reference to FIG. 2, UE 115-f may be an example of UE 115-b as described with reference to FIG. 2, UE 115-g may be an example of a UE 115-d as described with reference to FIG. 2, and UE 115-h may be an example of UE 115-c as described with reference to FIG. 2.

At 305-a, UE 115-e may be configured or preconfigured with a multi-path rule. Additionally, at 305-b, UE 115-h may be configured or preconfigured with the multi-path rule. In some examples, UEs 115-e and 115-h may be configured with the multi-path rule at the ProSe layer. In such examples, when a new service is to be used, UE 115-e may determine one or more communication parameters (e.g., path or bearer information, such as path type, bearer type, or access type) according to the rule for each PC5 QoS flow. In other examples, UEs 115-e and 115-h may be configured with the multi-path rule at the RRC layer. In some such examples, the multi-path rule may be defined as a mapping between one or more communication parameters (e.g., bearer or path information, such as bearer type, path type, or access type) and service information. Additionally, the multi-path rule may include PC5 QOS parameters and source and/or destination link IDs. Additionally, the rule may include service information (e.g., the service type, the application layer). In some such examples, UE 115-e may determine the path information according to the received parameters from the upper layer (e.g., the one or more communication parameters, the PC5 QoS parameters) and/or the source or destination link ID.

At 310, UE 115-e may establish an end-to-end link with UE 115-h for communicating traffic associated with a service, the end-to-end link including a first path. In some such example, the first path may include a relay UE (e.g., UE 115-f). In some such examples (e.g., when the multi-path rule is configured at the ProSe layer), UE 115-e may negotiate the one or more communication parameters with UE 115-h (e.g., may perform enhanced QoS negotiation). For instance, UE 115-e may send values of the one or more communication parameter corresponding to particular service information and/or particular QoS parameters to UE 115-h (e.g., along the first path via UE 115-f). UE 115-h may determine whether to accept the values of the one or more communication parameters for each service and QoS parameters according to the configured or preconfigured multi-path rule and may respond to UE 115-e the accepted service and values of communication parameters (e.g., along the first path via UE 115-f).

At 315, UE 115-e may discover UE 115-g and may select UE 115-g for use as a relay UE.

At 320, UE 115-e may transmit, via the end-to-end link, an indication of a configuration for a second path between UE 115-e and UE 115-h, where the configuration for the second path is based on service information associated with a service for which the end-to-end link was established. For instance, UE 115-e may transmit one or more communication parameter values for a second path to UE 115-h, where UE 115-h may determine whether or not to accept the second path addition. Additionally (e.g., if the multi-path rule is implemented at the RRC layer), UE 115-e may transmit one or more QoS parameters to UE 115-h, which UE 115-h may use to determine whether to accept the second path addition and the one or more communication parameter values according to the multi-path rule.

At 325-a, UE 115-e may perform PC5-S connection setup with UE 115-g. Additionally, at 325-b, UE 115-h may perform PC5-S connection setup with UE 115-g. After performing the PC5-S connection setup with UE 115-g, UE 115-e may transmit one or more end-to-end QoS profiles to UE 115-g at 330. At 335-a, UE 115-e may perform PC5-RRC connection setup with UE 115-g. Additionally, at 335-b, UE 115-h may perform PC5-RRC connection setup with UE 115-g.

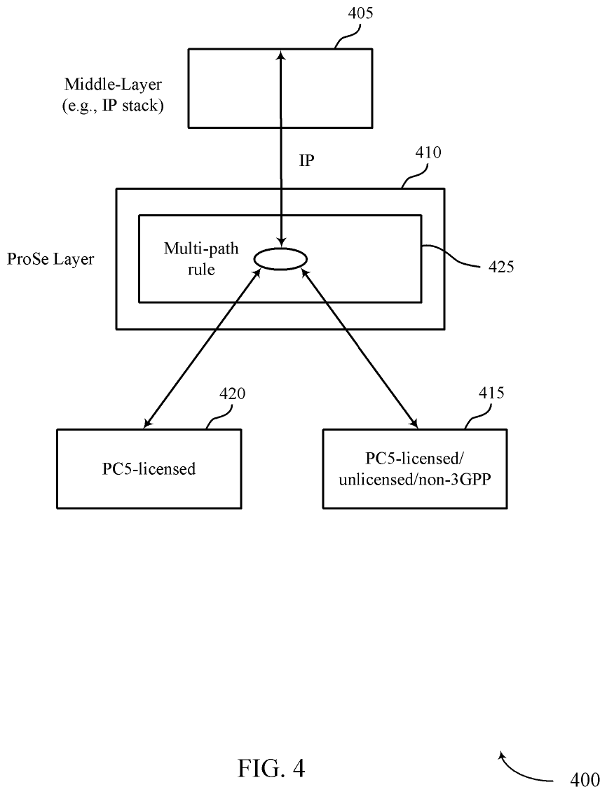

FIG. 4 illustrates an example of a multi-path rule implementation 400 that supports network control of multi-path sidelink operation in accordance with one or more aspects of the present disclosure. For instance, multi-path rule implementation may include a middle layer 405 (e.g., an IP stack), a ProSe layer 410, and access type configurations 415 and 420. Access type configuration 420 may correspond to PC-5-licensed and access type configuration 415 may correspond to PC5-licensed, PC5-unlicensed, and non-3GPP communications. In some examples, ProSe layer 410 may include a multi-path rule 425, where the multi-path rule may map an aspect of the middle layer 405 (e.g., IP) with an access type configuration (e.g., one or both of access type configurations 415 and 420).

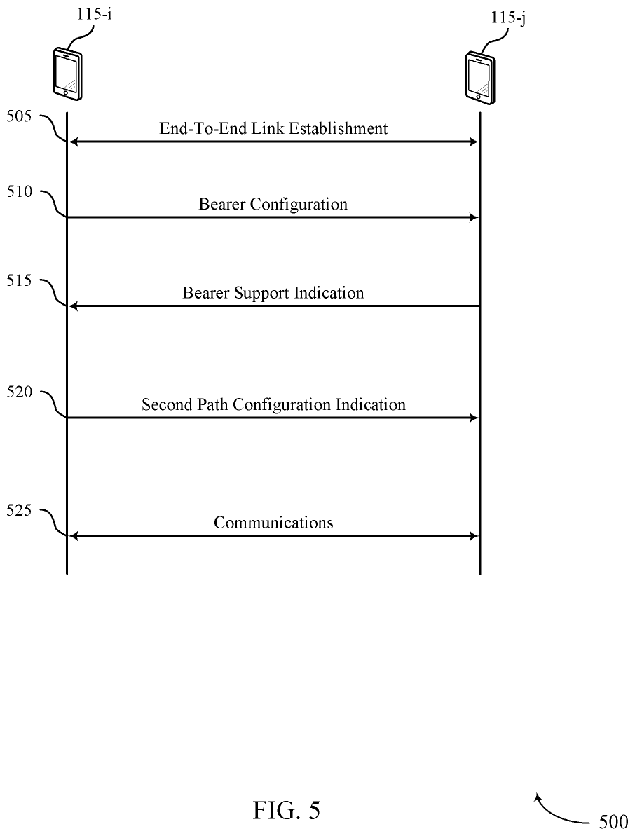

FIG. 5 illustrates an example of a process flow 500 that supports network control of multi-path sidelink operation in accordance with one or more aspects of the present disclosure. In some examples, process flow 500 may implement one or more aspects of wireless communications system 100 and/or 200. For instance, UE 115-i and/or UE 115-j may be examples of UEs 115 as described with reference to FIG. 1. Additionally or alternatively, UE 115-i may be an example of a UE 115-a as described with reference to FIG. 2 and UE 115-j may be an example of a UE 115-c as described with reference to FIG. 2.

At 505, UE 115-i may establish an end-to-end link with UE 115-j for communicating traffic associated with a service, the end-to-end link including a first path.

At 510, UE 115-i may transmit, to UE 115-j, an indication of a bearer configuration, where the bearer configuration is based on service information associated with the service.

At 515, UE 115-j may transmit, to UE 115-i, an indication that UE 115-j accepts the bearer configuration.

At 520, UE 115-i may transmit, to UE 115-j and via the end-to-end link, an indication of a configuration for a second path between UE 115-i and UE 115-j, where the configuration for the second path is based on service information associated with the service. In some examples, transmitting the indication of the configuration for the second path may include transmitting an indication of whether the second path is associated with a split bearer or a standalone bearer, an indication of a quantity of paths, an indication of an access type for the second path, or an indication of whether the second path is a direct path from UE 115-i to UE 115-j or a relay path, where the relay path includes at least one hop from UE 115-i to UE 115-j. In some examples, the service information may include an indication of a service type, an indication of an application layer, an indication of a packet filter set, or any combination thereof.

At 525, UE 115-i may communicate, with UE 115-j, traffic associated with the service via the first path or the second path based on transmitting the indication of the configuration for the second path. In some examples, communicating the traffic associated with the service via the first path or the second path may be based on communicating the indication of whether the second path is associated with the split bearer or the standalone bearer, the indication of the quantity of paths, the indication of the access type for the second path, or the indication of whether the second path is a direct path from UE 115-i to UE 115-j or the relay path. In some examples, communicating the traffic associated with the service via the first path or the second path is based on receiving the indication that UE 115-j accepts the bearer configuration.

In some examples, UE 115-i may transmit, via the end-to-end link, an indication of service information. Additionally, UE 115-j may transmit, to UE 115-i, an indication of a subset of the set of access types. In some such examples, communicating the traffic associated with the service via the first path or the second path may be based on communicating the indication of the subset of the set of access types.

In some examples, UE 115-i may determine the configuration for the second path a first layer of UE 115-i based on the service information and may provide the configuration for the second path an indication of a QoS flow to a second layer of UE 115-i. In some such examples, communicating the traffic associated with the service via the first path or the second path is based on providing the configuration for the second path and the indication of the QoS flow to the second layer of UE 115-i. Additionally or alternatively, UE 115-i may provide, by the first layer of UE 115-i, the service information and a QoS flow to the second layer of UE 115-i. UE 115-i may determine the configuration for the second path at the second layer based on the provided service information. In some such examples, communicating the traffic associated with the service via the first path or the second path may be based on determining the configuration for the second path at the second layer. In some examples, UE 115-i may provide, by the first layer of UE 115-i, an identifier of UE 115-i, an identifier of UE 115-k, or both, where determining the configuration for the second path is based on the identifier of UE 115-i, the identifier of UE 115-j, or both. In some examples, the first layer may be a ProSe layer and the second layer may be an RRC layer.

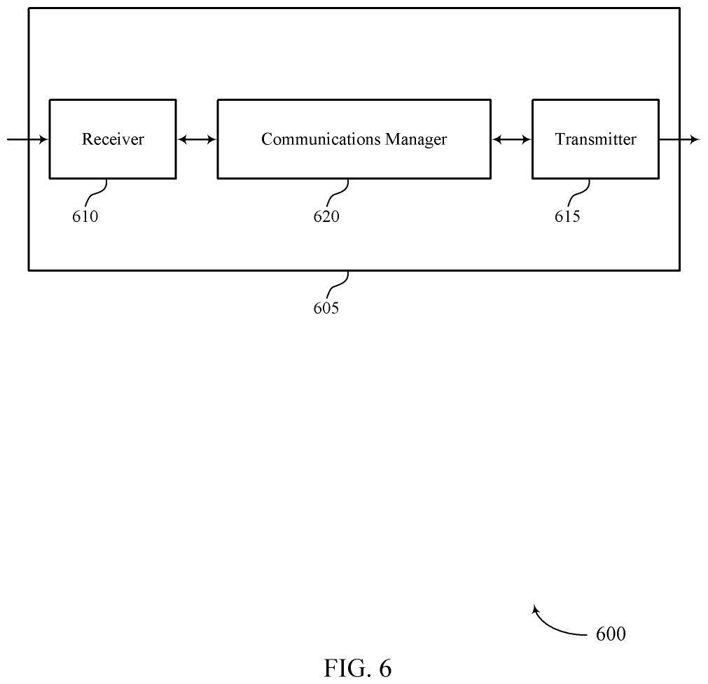

FIG. 6 shows a block diagram 600 of a device 605 that supports network control of multi-path sidelink operation in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to network control of multi-path sidelink operation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to network control of multi-path sidelink operation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of network control of multi-path sidelink operation as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first UE in accordance with examples as disclosed herein. For example, the communications manager 620 may be configured as or otherwise support a means for establishing an end-to-end link with a second UE for communicating traffic associated with a service, the end-to-end link including a first path. The communications manager 620 may be configured as or otherwise support a means for transmitting, via the end-to-end link, an indication of a configuration for a second path between the first UE and the second UE, where the configuration for the second path is based on service information associated with the service. The communications manager 620 may be configured as or otherwise support a means for communicating, with the second UE, traffic associated with the service via the first path or the second path based on transmitting the indication of the configuration for the second path.

Additionally, or alternatively, the communications manager 620 may support wireless communication at a first UE in accordance with examples as disclosed herein. For example, the communications manager 620 may be configured as or otherwise support a means for establishing an end-to-end link with a second UE for communicating traffic associated with a service, the end-to-end link including a first path. The communications manager 620 may be configured as or otherwise support a means for receiving, via the end-to-end link, an indication of a configuration for a second path between the first UE and the second UE, where the configuration for the second path is based on service information associated with the service. The communications manager 620 may be configured as or otherwise support a means for communicating, with the second UE, traffic associated with the service via the first path or the second path based on transmitting the indication of the configuration for the second path.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for the device 605 to meet constraints specific to each instance of service information and/or may enable the device to set up multi-path configurations with values of communication parameters that exhibit improved signal characteristics as compared to other values for the communication parameters.

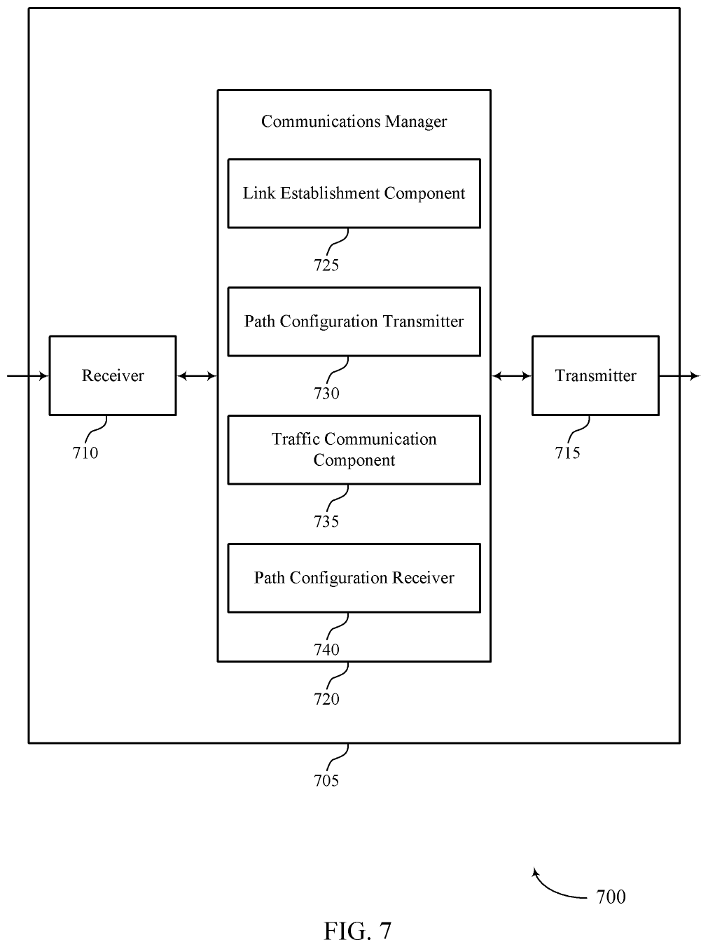

FIG. 7 shows a block diagram 700 of a device 705 that supports network control of multi-path sidelink operation in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to network control of multi-path sidelink operation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to network control of multi-path sidelink operation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of network control of multi-path sidelink operation as described herein. For example, the communications manager 720 may include a link establishment component 725, a path configuration transmitter 730, a traffic communication component 735, a path configuration receiver 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE in accordance with examples as disclosed herein. The link establishment component 725 may be configured as or otherwise support a means for establishing an end-to-end link with a second UE for communicating traffic associated with a service, the end-to-end link including a first path. The path configuration transmitter 730 may be configured as or otherwise support a means for transmitting, via the end-to-end link, an indication of a configuration for a second path between the first UE and the second UE, where the configuration for the second path is based on service information associated with the service. The traffic communication component 735 may be configured as or otherwise support a means for communicating, with the second UE, traffic associated with the service via the first path or the second path based on transmitting the indication of the configuration for the second path.

Additionally, or alternatively, the communications manager 720 may support wireless communication at a first UE in accordance with examples as disclosed herein. The link establishment component 725 may be configured as or otherwise support a means for establishing an end-to-end link with a second UE for communicating traffic associated with a service, the end-to-end link including a first path. The path configuration receiver 740 may be configured as or otherwise support a means for receiving, via the end-to-end link, an indication of a configuration for a second path between the first UE and the second UE, where the configuration for the second path is based on service information associated with the service. The traffic communication component 735 may be configured as or otherwise support a means for communicating, with the second UE, traffic associated with the service via the first path or the second path based on transmitting the indication of the configuration for the second path.

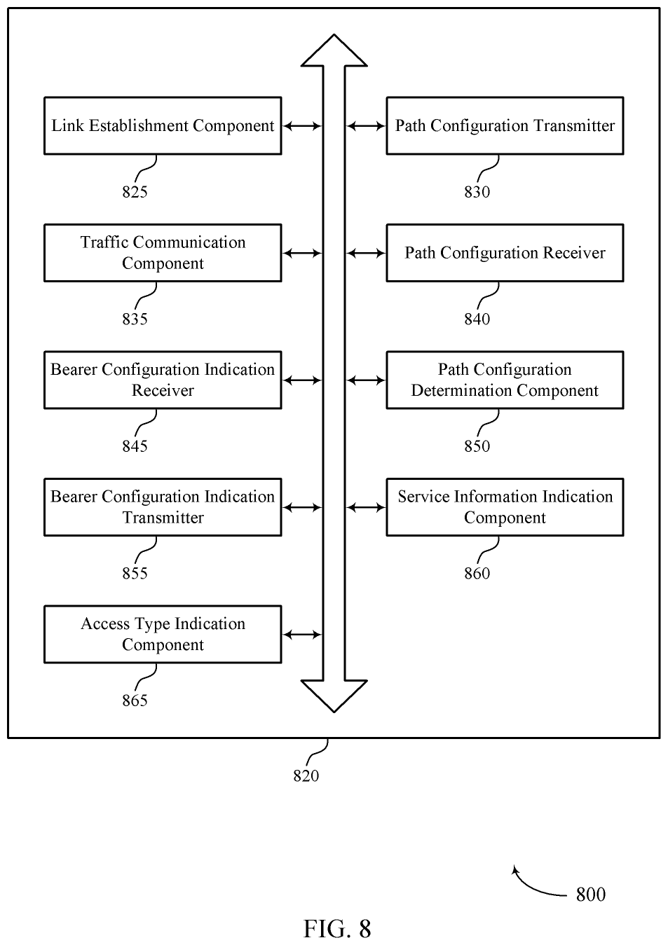

FIG. 8 shows a block diagram 800 of a communications manager 820 that supports network control of multi-path sidelink operation in accordance with one or more aspects of the present disclosure. The communications manager 820 may be an example of aspects of a communications manager 620, a communications manager 720, or both, as described herein. The communications manager 820, or various components thereof, may be an example of means for performing various aspects of network control of multi-path sidelink operation as described herein. For example, the communications manager 820 may include a link establishment component 825, a path configuration transmitter 830, a traffic communication component 835, a path configuration receiver 840, a bearer configuration indication receiver 845, a path configuration determination component 850, a bearer configuration indication transmitter 855, a service information indication component 860, an access type indication component 865, or any combination thereof. Each of these components may communicate, directly or indirectly, with one another (e.g., via one or more buses).

The communications manager 820 may support wireless communication at a first UE in accordance with examples as disclosed herein. The link establishment component 825 may be configured as or otherwise support a means for establishing an end-to-end link with a second UE for communicating traffic associated with a service, the end-to-end link including a first path. The path configuration transmitter 830 may be configured as or otherwise support a means for transmitting, via the end-to-end link, an indication of a configuration for a second path between the first UE and the second UE, where the configuration for the second path is based on service information associated with the service. The traffic communication component 835 may be configured as or otherwise support a means for communicating, with the second UE, traffic associated with the service via the first path or the second path based on transmitting the indication of the configuration for the second path.

In some examples, to support transmitting the indication of the configuration for the second path, the path configuration transmitter 830 may be configured as or otherwise support a means for transmitting, via the end-to-end link, an indication of whether the second path is associated with a split bearer or a standalone bearer, where communicating the traffic associated with the service via the first path or the second path is based on transmitting the indication of whether the second path is associated with the split bearer or the standalone bearer.

In some examples, to support transmitting the indication of the configuration for the second path, the path configuration transmitter 830 may be configured as or otherwise support a means for transmitting, via the end-to-end link, an indication of a quantity of paths, where communicating the traffic associated with the service via the first path or the second path is based on transmitting the indication of the quantity of paths.

In some examples, to support transmitting the indication of the configuration for the second path, the path configuration transmitter 830 may be configured as or otherwise support a means for transmitting, via the end-to-end link, an indication of an access type for the second path, where communicating the traffic associated with the service via the first path or the second path is based on transmitting the indication of the access type for the second path.

In some examples, the indication of the access type includes an indication of a set of access types, and the service information indication component 860 may be configured as or otherwise support a means for transmitting, via the end-to-end link, an indication of the service information. In some examples, the indication of the access type includes an indication of a set of access types, and the access type indication component 865 may be configured as or otherwise support a means for receiving, from the second UE, an indication of a subset of the set of access types. In some examples, the indication of the access type includes an indication of a set of access types, and the traffic communication component 835 may be configured as or otherwise support a means for communicating the traffic associated with the service via the first path or the second path based on receiving the indication of the subset of the set of access types.

In some examples, to support transmitting the indication of the configuration for the second path, the path configuration transmitter 830 may be configured as or otherwise support a means for transmitting, via the end-to-end link, an indication of whether the second path is a direct path from the first UE to the second UE or is a relay path, where the relay path includes at least one hop from the first UE to the second UE via at least one relay UE.

In some examples, the path configuration transmitter 830 may be configured as or otherwise support a means for transmitting, to the second UE, an indication of a bearer configuration, where the bearer configuration is based on the service information. In some examples, the bearer configuration indication receiver 845 may be configured as or otherwise support a means for receiving, from the second UE, an indication that the second UE accepts the bearer configuration, where communicating the traffic associated with the service via the first path or the second path is based on receiving the indication that the second UE accepts the bearer configuration.

In some examples, the path configuration determination component 850 may be configured as or otherwise support a means for determining the configuration for the second path at a first layer of the first UE based on the service information. In some examples, the path configuration determination component 850 may be configured as or otherwise support a means for providing the configuration for the second path and an indication of a quality of service (QOS) flow to a second layer of the first UE. In some examples, the traffic communication component 835 may be configured as or otherwise support a means for communicating the traffic associated with the service via the first path or the second path based on providing the configuration for the second path and the indication of the QoS flow to the second layer of the first UE.

In some examples, the first layer includes a proximity services layer and the second layer includes a radio resource control layer.

In some examples, the path configuration determination component 850 may be configured as or otherwise support a means for providing, by a first layer of the first UE, the service information and a quality of service (QOS) flow to a second layer of the first UE. In some examples, the path configuration determination component 850 may be configured as or otherwise support a means for determining the configuration for the second path at the second layer based on the provided service information. In some examples, the traffic communication component 835 may be configured as or otherwise support a means for communicating the traffic associated with the service via the first path or the second path based on determining the configuration for the second path at the second layer.

In some examples, the path configuration determination component 850 may be configured as or otherwise support a means for providing, by the first layer of the first UE, an identifier of the first UE, an identifier of the second UE, or both, where determining the configuration for the second path is based on the identifier of the first UE, the identifier of the second UE, or both.

In some examples, the first layer includes a proximity services layer and the second layer includes a radio resource control layer.

In some examples, the service information includes an indication of a service type, an indication of an application layer, an indication of a packet filter set, or any combination thereof.

Additionally, or alternatively, the communications manager 820 may support wireless communication at a first UE in accordance with examples as disclosed herein. In some examples, the link establishment component 825 may be configured as or otherwise support a means for establishing an end-to-end link with a second UE for communicating traffic associated with a service, the end-to-end link including a first path. The path configuration receiver 840 may be configured as or otherwise support a means for receiving, via the end-to-end link, an indication of a configuration for a second path between the first UE and the second UE, where the configuration for the second path is based on service information associated with the service. In some examples, the traffic communication component 835 may be configured as or otherwise support a means for communicating, with the second UE, traffic associated with the service via the first path or the second path based on transmitting the indication of the configuration for the second path.

In some examples, to support receiving the indication of the configuration for the second path, the path configuration receiver 840 may be configured as or otherwise support a means for receiving, via the end-to-end link, an indication of whether the second path is associated with a split bearer or a standalone bearer, where communicating the traffic associated with the service via the first path or the second path is based on transmitting the indication of whether the second path is associated with the split bearer or the standalone bearer.

In some examples, to support receiving the indication of the configuration for the second path, the path configuration receiver 840 may be configured as or otherwise support a means for receiving, via the end-to-end link, an indication of a quantity of paths, where communicating the traffic associated with the service via the first path or the second path is based on transmitting the indication of the quantity of paths.

In some examples, to support receiving the indication of the configuration for the second path, the path configuration receiver 840 may be configured as or otherwise support a means for receiving, via the end-to-end link, an indication of an access type for the second path, where communicating the traffic associated with the service via the first path or the second path is based on transmitting the indication of the access type for the second path.

In some examples, the indication of the access type includes an indication of a set of access types, and the service information indication component 860 may be configured as or otherwise support a means for receiving, via the end-to-end link, an indication of the service information. In some examples, the indication of the access type includes an indication of a set of access types, and the access type indication component 865 may be configured as or otherwise support a means for transmitting, to the second UE, an indication of a subset of the set of access types. In some examples, the indication of the access type includes an indication of a set of access types, and the traffic communication component 835 may be configured as or otherwise support a means for communicating the traffic associated with the service via the first path or the second path based on receiving the indication of the subset of the set of access types.

In some examples, to support receiving the indication of the configuration for the second path, the path configuration receiver 840 may be configured as or otherwise support a means for receiving, via the end-to-end link, an indication of whether the second path is a direct path from the first UE to the second UE or is a relay path, where the relay path includes at least one hop from the first UE to the second UE via at least one relay UE.

In some examples, the path configuration receiver 840 may be configured as or otherwise support a means for receiving, from the second UE, an indication of a bearer configuration, where the bearer configuration is based on the service information. In some examples, the bearer configuration indication transmitter 855 may be configured as or otherwise support a means for transmitting, to the second UE, an indication that the first UE accepts the bearer configuration, where communicating the traffic associated with the service via the first path or the second path is based on transmitting the indication that the first UE accepts the bearer configuration.

In some examples, the service information includes an indication of a service type, an indication of an application layer, an indication of a packet filter set, or any combination thereof.

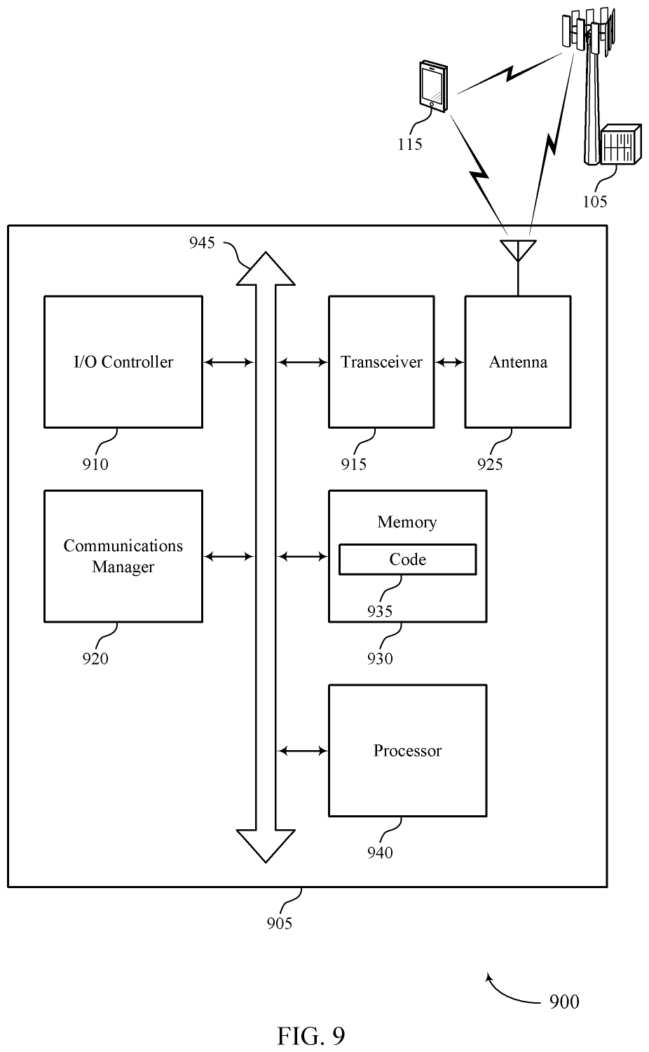

FIG. 9 shows a diagram of a system 900 including a device 905 that supports network control of multi-path sidelink operation in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting network control of multi-path sidelink operation). For example, the device 905 or a component of the device 905 may include a processor 940 and memory 930 coupled with or to the processor 940, the processor 940 and memory 930 configured to perform various functions described herein.

The communications manager 920 may support wireless communication at a first UE in accordance with examples as disclosed herein. For example, the communications manager 920 may be configured as or otherwise support a means for establishing an end-to-end link with a second UE for communicating traffic associated with a service, the end-to-end link including a first path. The communications manager 920 may be configured as or otherwise support a means for transmitting, via the end-to-end link, an indication of a configuration for a second path between the first UE and the second UE, where the configuration for the second path is based on service information associated with the service. The communications manager 920 may be configured as or otherwise support a means for communicating, with the second UE, traffic associated with the service via the first path or the second path based on transmitting the indication of the configuration for the second path.

Additionally, or alternatively, the communications manager 920 may support wireless communication at a first UE in accordance with examples as disclosed herein. For example, the communications manager 920 may be configured as or otherwise support a means for establishing an end-to-end link with a second UE for communicating traffic associated with a service, the end-to-end link including a first path. The communications manager 920 may be configured as or otherwise support a means for receiving, via the end-to-end link, an indication of a configuration for a second path between the first UE and the second UE, where the configuration for the second path is based on service information associated with the service. The communications manager 920 may be configured as or otherwise support a means for communicating, with the second UE, traffic associated with the service via the first path or the second path based on transmitting the indication of the configuration for the second path.

By including or configuring the communications manager 920 in accordance with examples as described herein, the device 905 may support techniques for the device 905 to meet constraints specific to each instance of service information and/or may enable the device to set up multi-path configurations with values of communication parameters that exhibit improved signal characteristics as compared to other values for the communication parameters.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of network control of multi-path sidelink operation as described herein, or the processor 940 and the memory 930 may be otherwise configured to perform or support such operations.

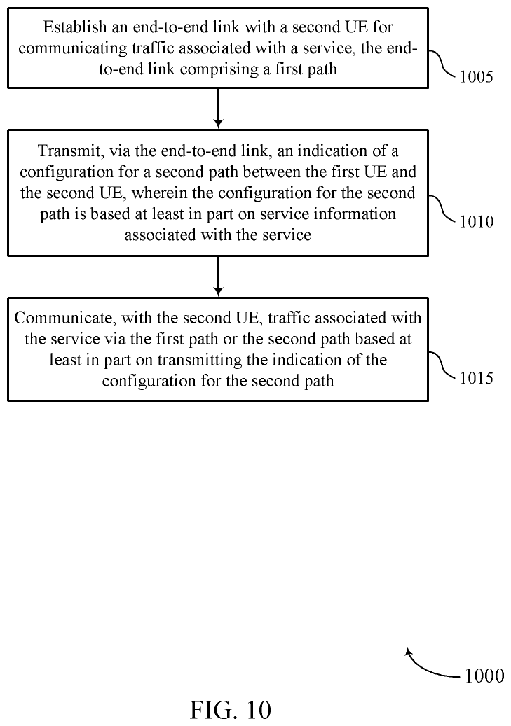

FIG. 10 shows a flowchart illustrating a method 1000 that supports network control of multi-path sidelink operation in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include establishing an end-to-end link with a second UE for communicating traffic associated with a service, the end-to-end link including a first path. The operations of 1005 may be performed in accordance with examples as disclosed herein. In some examples, aspects of the operations of 1005 may be performed by a link establishment component 825 as described with reference to FIG. 8.

At 1010, the method may include transmitting, via the end-to-end link, an indication of a configuration for a second path between the first UE and the second UE, where the configuration for the second path is based on service information associated with the service. The operations of 1010 may be performed in accordance with examples as disclosed herein. In some examples, aspects of the operations of 1010 may be performed by a path configuration transmitter 830 as described with reference to FIG. 8.

At 1015, the method may include communicating, with the second UE, traffic associated with the service via the first path or the second path based on transmitting the indication of the configuration for the second path. The operations of 1015 may be performed in accordance with examples as disclosed herein. In some examples, aspects of the operations of 1015 may be performed by a traffic communication component 835 as described with reference to FIG. 8.

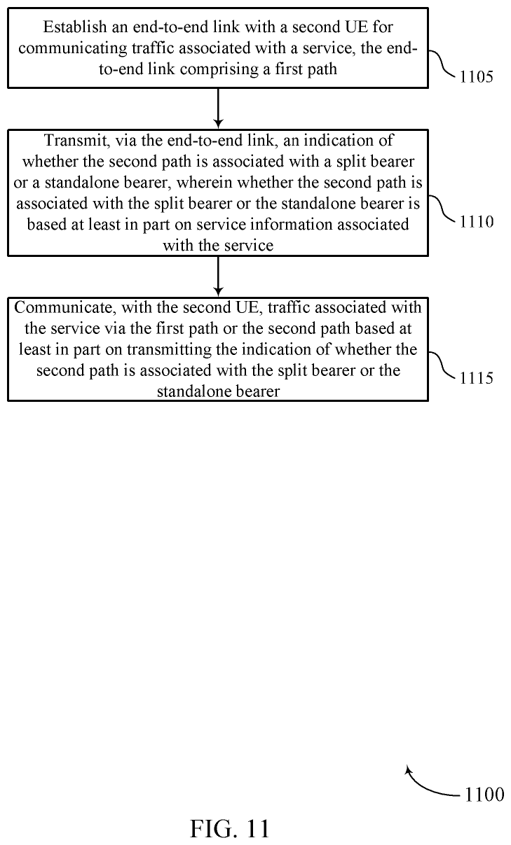

FIG. 11 shows a flowchart illustrating a method 1100 that supports network control of multi-path sidelink operation in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include establishing an end-to-end link with a second UE for communicating traffic associated with a service, the end-to-end link including a first path. The operations of 1105 may be performed in accordance with examples as disclosed herein. In some examples, aspects of the operations of 1105 may be performed by a link establishment component 825 as described with reference to FIG. 8.

At 1110, the method may include transmitting, via the end-to-end link, an indication of whether the second path is associated with a split bearer or a standalone bearer, wherein whether the second path is associated with the split bearer or the standalone bearer is based at least in part on service information associated with the service. The operations of 1110 may be performed in accordance with examples as disclosed herein. In some examples, aspects of the operations of 1110 may be performed by a path configuration transmitter 830 as described with reference to FIG. 8.

At 1115, the method may include communicating, with the second UE, traffic associated with the service via the first path or the second path based at least in part on transmitting the indication of whether the second path is associated with the split bearer or the standalone bearer. The operations of 1115 may be performed in accordance with examples as disclosed herein. In some examples, aspects of the operations of 1115 may be performed by a traffic communication component 835 as described with reference to FIG. 8.

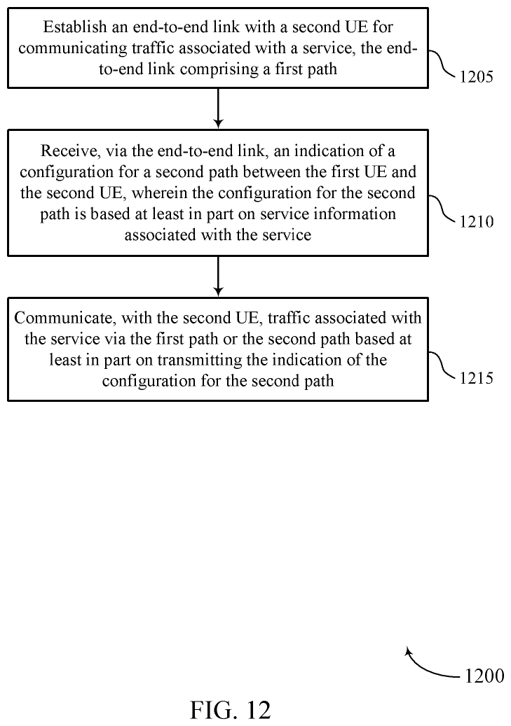

FIG. 12 shows a flowchart illustrating a method 1200 that supports network control of multi-path sidelink operation in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include establishing an end-to-end link with a second UE for communicating traffic associated with a service, the end-to-end link including a first path. The operations of 1205 may be performed in accordance with examples as disclosed herein. In some examples, aspects of the operations of 1205 may be performed by a link establishment component 825 as described with reference to FIG. 8.

At 1210, the method may include receiving, via the end-to-end link, an indication of a configuration for a second path between the first UE and the second UE, where the configuration for the second path is based on service information associated with the service. The operations of 1210 may be performed in accordance with examples as disclosed herein. In some examples, aspects of the operations of 1210 may be performed by a path configuration receiver 840 as described with reference to FIG. 8.

At 1215, the method may include communicating, with the second UE, traffic associated with the service via the first path or the second path based on transmitting the indication of the configuration for the second path. The operations of 1215 may be performed in accordance with examples as disclosed herein. In some examples, aspects of the operations of 1215 may be performed by a traffic communication component 835 as described with reference to FIG. 8.

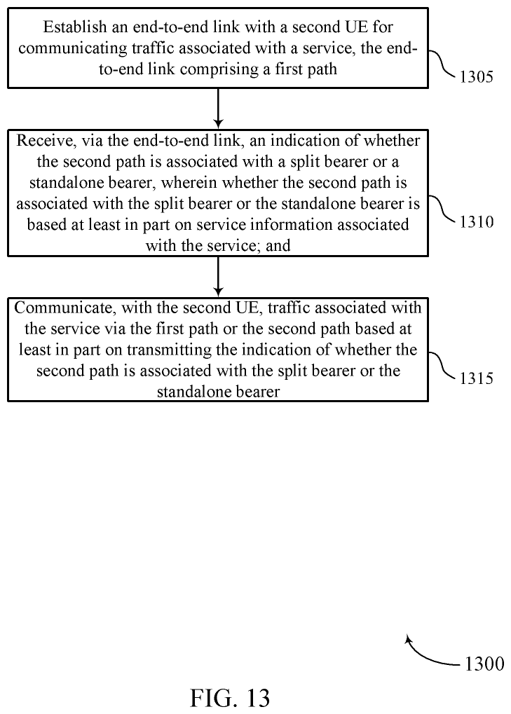

FIG. 13 shows a flowchart illustrating a method 1300 that supports network control of multi-path sidelink operation in accordance with one or more aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include establishing an end-to-end link with a second UE for communicating traffic associated with a service, the end-to-end link including a first path. The operations of 1305 may be performed in accordance with examples as disclosed herein. In some examples, aspects of the operations of 1305 may be performed by a link establishment component 825 as described with reference to FIG. 8.

At 1310, the method may include receiving, via the end-to-end link, an indication of whether the second path is associated with a split bearer or a standalone bearer, wherein whether the second path is associated with the split bearer or the standalone bearer is based at least in part on service information associated with the service. The operations of 1310 may be performed in accordance with examples as disclosed herein. In some examples, aspects of the operations of 1310 may be performed by a path configuration receiver 840 as described with reference to FIG. 8.

At 1315, the method may include communicating, with the second UE, traffic associated with the service via the first path or the second path based at least in part on transmitting the indication of whether the second path is associated with the split bearer or the standalone bearer. The operations of 1315 may be performed in accordance with examples as disclosed herein. In some examples, aspects of the operations of 1315 may be performed by a traffic communication component 835 as described with reference to FIG. 8.

The following provides an overview of aspects of the present disclosure:
Aspect 1: A method for wireless communication at a first UE, comprising: establishing an end-to-end link with a second UE for communicating traffic associated with a service, the end-to-end link comprising a first path; transmitting, via the end-to-end link, an indication of a configuration for a second path between the first UE and the second UE, wherein the configuration for the second path is based at least in part on service information associated with the service; and communicating, with the second UE, traffic associated with the service via the first path or the second path based at least in part on transmitting the indication of the configuration for the second path.
Aspect 2: The method of aspect 1, wherein transmitting the indication of the configuration for the second path comprises: transmitting, via the end-to-end link, an indication of whether the second path is associated with a split bearer or a standalone bearer, wherein communicating the traffic associated with the service via the first path or the second path is based at least in part on transmitting the indication of whether the second path is associated with the split bearer or the standalone bearer.
Aspect 3: The method of any of aspects 1 through 2, wherein transmitting the indication of the configuration for the second path comprises: transmitting, via the end-to-end link, an indication of a quantity of paths, wherein communicating the traffic associated with the service via the first path or the second path is based at least in part on transmitting the indication of the quantity of paths.
Aspect 4: The method of any of aspects 1 through 3, wherein transmitting the indication of the configuration for the second path comprises: transmitting, via the end-to-end link, an indication of an access type for the second path, wherein communicating the traffic associated with the service via the first path or the second path is based at least in part on transmitting the indication of the access type for the second path.
Aspect 5: The method of aspect 4, wherein the indication of the access type comprises an indication of a set of access types, the method further comprising: transmitting, via the end-to-end link, an indication of the service information; receiving, from the second UE, an indication of a subset of the set of access types; and communicating the traffic associated with the service via the first path or the second path based at least in part on receiving the indication of the subset of the set of access types.
Aspect 6: The method of any of aspects 1 through 5, wherein transmitting the indication of the configuration for the second path comprises: transmitting, via the end-to-end link, an indication of whether the second path is a direct path from the first UE to the second UE or is a relay path, wherein the relay path comprises at least one hop from the first UE to the second UE via at least one relay UE.
Aspect 7: The method of any of aspects 1 through 6, further comprising: transmitting, to the second UE, an indication of a bearer configuration, wherein the bearer configuration is based at least in part on the service information; and receiving, from the second UE, an indication that the second UE accepts the bearer configuration, wherein communicating the traffic associated with the service via the first path or the second path is based at least in part on receiving the indication that the second UE accepts the bearer configuration.
Aspect 8: The method of any of aspects 1 through 7, further comprising: determining the configuration for the second path at a first layer of the first UE based at least in part on the service information; and providing the configuration for the second path and an indication of a quality of service (QOS) flow to a second layer of the first UE; communicating the traffic associated with the service via the first path or the second path based at least in part on providing the configuration for the second path and the indication of the QoS flow to the second layer of the first UE.
Aspect 9: The method of aspect 8, wherein the first layer comprises a proximity services layer and the second layer comprises a radio resource control layer.
Aspect 10: The method of any of aspects 1 through 9, further comprising: providing, by a first layer of the first UE, the service information and a quality of service (QOS) flow to a second layer of the first UE; determining the configuration for the second path at the second layer based at least in part on the provided service information; and communicating the traffic associated with the service via the first path or the second path based at least in part on determining the configuration for the second path at the second layer.
Aspect 11: The method of aspect 10, further comprising: providing, by the first layer of the first UE, an identifier of the first UE, an identifier of the second UE, or both, wherein determining the configuration for the second path is based at least in part on the identifier of the first UE, the identifier of the second UE, or both.
Aspect 12: The method of aspect 11, wherein the first layer comprises a proximity services layer and the second layer comprises a radio resource control layer.
Aspect 13: The method of any of aspects 1 through 12, wherein the service information comprises an indication of a service type, an indication of an application layer, an indication of a packet filter set, or any combination thereof.
Aspect 14: A method for wireless communication at a first UE, comprising: establishing an end-to-end link with a second UE for communicating traffic associated with a service, the end-to-end link comprising a first path; receiving, via the end-to-end link, an indication of a configuration for a second path between the first UE and the second UE, wherein the configuration for the second path is based at least in part on service information associated with the service; and communicating, with the second UE, traffic associated with the service via the first path or the second path based at least in part on transmitting the indication of the configuration for the second path.
Aspect 15: The method of aspect 14, wherein receiving the indication of the configuration for the second path comprises: receiving, via the end-to-end link, an indication of whether the second path is associated with a split bearer or a standalone bearer, wherein communicating the traffic associated with the service via the first path or the second path is based at least in part on transmitting the indication of whether the second path is associated with the split bearer or the standalone bearer.
Aspect 16: The method of any of aspects 14 through 15, wherein receiving the indication of the configuration for the second path comprises: receiving, via the end-to-end link, an indication of a quantity of paths, wherein communicating the traffic associated with the service via the first path or the second path is based at least in part on transmitting the indication of the quantity of paths.
Aspect 17: The method of any of aspects 14 through 16, wherein receiving the indication of the configuration for the second path comprises: receiving, via the end-to-end link, an indication of an access type for the second path, wherein communicating the traffic associated with the service via the first path or the second path is based at least in part on transmitting the indication of the access type for the second path.
Aspect 18: The method of aspect 17, wherein the indication of the access type comprises an indication of a set of access types, the method further comprising: receiving, via the end-to-end link, an indication of the service information; transmitting, to the second UE, an indication of a subset of the set of access types; and communicating the traffic associated with the service via the first path or the second path based at least in part on receiving the indication of the subset of the set of access types.
Aspect 19: The method of any of aspects 14 through 18, wherein receiving the indication of the configuration for the second path comprises: receiving, via the end-to-end link, an indication of whether the second path is a direct path from the first UE to the second UE or is a relay path, wherein the relay path comprises at least one hop from the first UE to the second UE via at least one relay UE.
Aspect 20: The method of any of aspects 14 through 19, further comprising: receiving, from the second UE, an indication of a bearer configuration, wherein the bearer configuration is based at least in part on the service information; and transmitting, to the second UE, an indication that the first UE accepts the bearer configuration, wherein communicating the traffic associated with the service via the first path or the second path is based at least in part on transmitting the indication that the first UE accepts the bearer configuration.
Aspect 21: The method of any of aspects 14 through 20, wherein the service information comprises an indication of a service type, an indication of an application layer, an indication of a packet filter set, or any combination thereof.
Aspect 22: An apparatus for wireless communication at a first UE, comprising a processor; memory coupled with the processor; and instructions stored in the memory and executable by the processor to cause the apparatus to perform a method of any of aspects 1 through 13.
Aspect 23: An apparatus for wireless communication at a first UE, comprising at least one means for performing a method of any of aspects 1 through 13.
Aspect 24: A non-transitory computer-readable medium storing code for wireless communication at a first UE, the code comprising instructions executable by a processor to perform a method of any of aspects 1 through 13.
Aspect 25: An apparatus for wireless communication at a first UE, comprising a processor; memory coupled with the processor; and instructions stored in the memory and executable by the processor to cause the apparatus to perform a method of any of aspects 14 through 21.
Aspect 26: An apparatus for wireless communication at a first UE, comprising at least one means for performing a method of any of aspects 14 through 21.
Aspect 27: A non-transitory computer-readable medium storing code for wireless communication at a first UE, the code comprising instructions executable by a processor to perform a method of any of aspects 14 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a first user equipment (UE), comprising:
establishing an end-to-end link with a second UE for communicating traffic associated with a service, the end-to-end link comprising a first path;
transmitting, via the end-to-end link, an indication of a configuration for a second path between the first UE and the second UE, wherein the configuration for the second path is based at least in part on service information associated with the service; and
communicating, with the second UE, traffic associated with the service via the first path or the second path based at least in part on transmitting the indication of the configuration for the second path.

2. The method of claim 1, wherein transmitting the indication of the configuration for the second path comprises:
transmitting, via the end-to-end link, an indication of whether the second path is associated with a split bearer or a standalone bearer, wherein communicating the traffic associated with the service via the first path or the second path is based at least in part on transmitting the indication of whether the second path is associated with the split bearer or the standalone bearer.

3. The method of claim 1, wherein transmitting the indication of the configuration for the second path comprises:
transmitting, via the end-to-end link, an indication of a quantity of paths, wherein communicating the traffic associated with the service via the first path or the second path is based at least in part on transmitting the indication of the quantity of paths.

4. The method of claim 1, wherein transmitting the indication of the configuration for the second path comprises:
transmitting, via the end-to-end link, an indication of an access type for the second path, wherein communicating the traffic associated with the service via the first path or the second path is based at least in part on transmitting the indication of the access type for the second path.

5. The method of claim 4, wherein the indication of the access type comprises an indication of a set of access types, the method further comprising:
transmitting, via the end-to-end link, an indication of the service information;
receiving, from the second UE, an indication of a subset of the set of access types; and
communicating the traffic associated with the service via the first path or the second path based at least in part on receiving the indication of the subset of the set of access types.

6. The method of claim 1, wherein transmitting the indication of the configuration for the second path comprises:
transmitting, via the end-to-end link, an indication of whether the second path is a direct path from the first UE to the second UE or is a relay path, wherein the relay path comprises at least one hop from the first UE to the second UE via at least one relay UE.

7. The method of claim 1, further comprising:
transmitting, to the second UE, an indication of a bearer configuration, wherein the bearer configuration is based at least in part on the service information; and
receiving, from the second UE, an indication that the second UE accepts the bearer configuration, wherein communicating the traffic associated with the service via the first path or the second path is based at least in part on receiving the indication that the second UE accepts the bearer configuration.

8. The method of claim 1, further comprising:
determining the configuration for the second path at a first layer of the first UE based at least in part on the service information;
providing the configuration for the second path and an indication of a quality of service (QOS) flow to a second layer of the first UE; and
communicating the traffic associated with the service via the first path or the second path based at least in part on providing the configuration for the second path and the indication of the QoS flow to the second layer of the first UE.

9. The method of claim 8, wherein the first layer comprises a proximity services layer and the second layer comprises a radio resource control layer.

10. The method of claim 1, further comprising:
providing, by a first layer of the first UE, the service information and a quality of service (QOS) flow to a second layer of the first UE;
determining the configuration for the second path at the second layer based at least in part on the provided service information; and
communicating the traffic associated with the service via the first path or the second path based at least in part on determining the configuration for the second path at the second layer.

11. The method of claim 10, further comprising:
providing, by the first layer of the first UE, an identifier of the first UE, an identifier of the second UE, or both, wherein determining the configuration for the second path is based at least in part on the identifier of the first UE, the identifier of the second UE, or both.

12. The method of claim 11, wherein the first layer comprises a proximity services layer and the second layer comprises a radio resource control layer.

13. (canceled)

14. A method for wireless communication at a first user equipment (UE), comprising:
establishing an end-to-end link with a second UE for communicating traffic associated with a service, the end-to-end link comprising a first path;
receiving, via the end-to-end link, an indication of a configuration for a second path between the first UE and the second UE, wherein the configuration for the second path is based at least in part on service information associated with the service; and
communicating, with the second UE, traffic associated with the service via the first path or the second path based at least in part on transmitting the indication of the configuration for the second path.

15. The method of claim 14, wherein receiving the indication of the configuration for the second path comprises:
receiving, via the end-to-end link, an indication of whether the second path is associated with a split bearer or a standalone bearer, wherein communicating the traffic associated with the service via the first path or the second path is based at least in part on transmitting the indication of whether the second path is associated with the split bearer or the standalone bearer.

16. The method of claim 14, wherein receiving the indication of the configuration for the second path comprises:
receiving, via the end-to-end link, an indication of a quantity of paths, wherein communicating the traffic associated with the service via the first path or the second path is based at least in part on transmitting the indication of the quantity of paths.

17. The method of claim 14, wherein receiving the indication of the configuration for the second path comprises:
receiving, via the end-to-end link, an indication of an access type for the second path, wherein communicating the traffic associated with the service via the first path or the second path is based at least in part on transmitting the indication of the access type for the second path.

18. The method of claim 17, wherein the indication of the access type comprises an indication of a set of access types, the method further comprising:
receiving, via the end-to-end link, an indication of the service information;
transmitting, to the second UE, an indication of a subset of the set of access types; and
communicating the traffic associated with the service via the first path or the second path based at least in part on receiving the indication of the subset of the set of access types.

19. The method of claim 14, wherein receiving the indication of the configuration for the second path comprises:
receiving, via the end-to-end link, an indication of whether the second path is a direct path from the first UE to the second UE or is a relay path, wherein the relay path comprises at least one hop from the first UE to the second UE via at least one relay UE.

20. The method of claim 14, further comprising:
receiving, from the second UE, an indication of a bearer configuration, wherein the bearer configuration is based at least in part on the service information; and
transmitting, to the second UE, an indication that the first UE accepts the bearer configuration, wherein communicating the traffic associated with the service via the first path or the second path is based at least in part on transmitting the indication that the first UE accepts the bearer configuration.

21. (canceled)

22. An apparatus for wireless communication at a first user equipment (UE), comprising:
a processor;
memory coupled with the processor; and
instructions stored in the memory and executable by the processor to cause the apparatus to:
establish an end-to-end link with a second UE for communicating traffic associated with a service, the end-to-end link comprising a first path;
transmit, via the end-to-end link, an indication of a configuration for a second path between the first UE and the second UE, wherein the configuration for the second path is based at least in part on service information associated with the service; and
communicate, with the second UE, traffic associated with the service via the first path or the second path based at least in part on transmitting the indication of the configuration for the second path.

23-30. (canceled)
